(19) United States
(12) Patent Application Publication
(10) Pub. No.: US 2024/0166339 A1
(43) Pub. Date: May 23, 2024

(54) COMPOSITE INTEGRATED RIBLETS

(71) Applicant: Boom Technology, Inc., Centennial, CO (US)

(72) Inventor: David Patrick Pels, Aurora, CO (US)

(21) Appl. No.: 18/506,199

(22) Filed: Nov. 10, 2023

Related U.S. Application Data
(60) Provisional application No. 63/384,293, filed on Nov. 18, 2022.

(51) Int. Cl. B64C 21/10; B29C 70/44; B32B 5/12

(52) U.S. Cl. CPC B64C 21/10; B29C 70/443; B32B 5/12; B29L 2031/3082; B32B 2260/023; B32B 2260/046; B32B 2605/18

(57) ABSTRACT

A composite material component including drag reduction features is provided. The drag reduction features include a plurality of riblets that are integrally formed in an external surface portion of the composite material component. The plurality of riblets may be integrally formed in a composite material of the component through a vacuum bagging fabrication process, a resin transfer molding process, or other such composite material fabrication process allowing for integral formation of the plurality of riblets.

### CROSS-REFERENCE TO RELATED APPLICATION

This application claims priority to U.S. Provisional Patent Application No. 63/384,293, filed on Nov. 18, 2022, entitled ‘COMPOSITE INTEGRATED RIBLETS,” the disclosure of which is incorporated herein in its entirety.

### TECHNICAL FIELD

This description relates, in general, to drag reduction features, and in particular, to the integration of drag reduction features into a composite material component.

### BACKGROUND

In general, an object moving through a medium (i.e., through a liquid or a gas) encounters a force that acts to resist or retard the motion of the object due to interaction with the medium surrounding the object. This force, which may be referred to as drag, acts in a direction opposite that of the direction of motion of the object, thus slowing the motion of the object through the medium. Drag may affect the motion of numerous different types of objects in this manner. For example, a motor vehicle may experience drag due to interaction with the air surrounding the motor vehicle as the motor vehicle moves through the air. Watercraft may experience drag due to interaction between a hull portion of the watercraft and water surrounding the hull portion, and also due to interaction between a superstructure portion of the watercraft and the air surrounding the superstructure portion, as the watercraft moves through the water/air. Similarly, an aircraft experiences drag due to interaction with the air surrounding the aircraft as the aircraft flies through the air.

In the case of an aircraft, performance impacts due to drag may be further affected by factors such as, for example, weight/weight distribution, environmental conditions, mode of operation of the aircraft including, for example, takeoff operation, cruise operation/maneuvers during cruise operation, landing operation, and the like. For example, aerodynamic drag, and in particular, increases in aerodynamic drag (for example, due to differences in aircraft cross-sectional area/cross-sectional profile), may have an adverse impact on aircraft performance during cruise operation, which may be amplified over relatively long ranges. Increases in aircraft weight may have similar adverse impacts on aircraft performance. These adverse impacts may be manifested in, for example, increased fuel consumption, decreased range, decreased cruise speeds, increased travel time, and the like. These adverse impacts may be further exacerbated in the operation of a supersonic aircraft, which relies on sustained supersonic cruise speeds and efficiency during cruise operation to complete relatively long range flights within given fuel consumption targets, flight times, and the like.

### SUMMARY

Systems and methods, in accordance with implementations described herein, provide drag reduction features for incorporation into composite material components. In some examples, the drag reduction features include features incorporated into an outer surface of a composite material component of an aircraft. In some examples, the drag reduction features are incorporated into an outer skin portion of the body of the aircraft, including, for example, a main body portion, a wing portion, one or more stability and control portions, and the like. In some examples, the drag reduction features include a plurality of riblets incorporated into the outer surface of one or more composite components defining the body of the aircraft. In some examples, the plurality of riblets are incorporated into the outer surface of the one or more composite components corresponding to a contour of the respective one or more components. In some examples, the plurality of riblets are incorporated into the outer surface of the one or more components in a manner corresponding to the aerodynamic profile of the aircraft. In some examples, a resin transfer molding process is implemented in the incorporation of the plurality of riblets into the surface of the composite component. In some examples, a vacuum bag molding process is implemented in the incorporation of the plurality of riblets into the surface of the composite component.

The incorporation of the drag reduction features including the plurality of riblets into the outer skin surface of the one or more composite components of the aircraft may reduce overall drag associated with operation of the aircraft during various different modes of operation. Reduction in drag may improve efficiency, particularly during long range cruise operation of the aircraft, through reduced fuel consumption and/or reduced fuel capacity requirements. In some situations, reduced fuel consumption/reduced fuel capacity requirements may produce a reduction in overall weight, and/or may allow space that would be otherwise allocated for fuel storage to be re-allocated for other aircraft systems and/or may allow for further refinement of the aerodynamic profile of the aircraft. In some situations, reduced fuel consumption may allow for increased range of the aircraft for a given fuel carrying capacity.

In some aspects, the techniques described herein relate to a composite material component, including: a resin material; fiber materials arranged in the resin material; and a plurality of riblets integrally formed in an external surface of the resin material, the external surface of the resin material defining a fluid-dynamic surface of the composite material component.

In some aspects, the techniques described herein relate to a composite material component, wherein each of the plurality of riblets has substantially the same cross-sectional shape.

In some aspects, the techniques described herein relate to a composite material component, wherein each of the plurality of riblets has a triangular cross-sectional shape.

In some aspects, the techniques described herein relate to a composite material component, wherein each of the plurality of riblets has a cross-sectional shape defined by an equilateral triangle.

In some aspects, the techniques described herein relate to a composite material component, wherein peaks of the plurality of riblets form an acute angle.

In some aspects, the techniques described herein relate to a composite material component, wherein troughs between adjacent riblets of the plurality of riblets form an acute angle.

In some aspects, the techniques described herein relate to a composite material component, wherein the plurality of riblets are arranged substantially in parallel to each other along a longitudinal direction of the plurality of riblets.

In some aspects, the techniques described herein relate to a composite material component, wherein a spacing between peaks of adjacent riblets of the plurality of riblets is substantially uniform across the plurality of riblets, and a spacing between troughs formed between adjacent riblets of the plurality of riblets is substantially uniform across the plurality of riblets.

In some aspects, the techniques described herein relate to a composite material component, wherein the composite material component is a skin portion of an aircraft, and wherein the plurality of riblets are integrally formed in the resin material defining an aerodynamic surface of the skin portion of an aircraft to reduce skin friction drag at the aerodynamic surface of the skin portion of the aircraft.

In some aspects, the techniques described herein relate to a composite material component, wherein the plurality of riblets integrally formed in the resin material defining the aerodynamic surface of the skin portion of the aircraft, in a direction corresponding to an airflow direction at the aerodynamic surface of the skin portion of the aircraft.

In some aspects, the techniques described herein relate to a composite material component, wherein the composite material component includes at least one of a fuselage portion of an aircraft, a wing portion of the aircraft, a nacelle portion of the aircraft, or a control surface portion of the aircraft, and wherein the plurality of riblets are integrally formed in the resin material defining an aerodynamic surface of the composite material component, aligned with an airflow direction at the aerodynamic surface of the composite material component.

In some aspects, the techniques described herein relate to a method of fabricating a composite material component, including: arranging fiber material in a mold, the mold having a pattern formed therein, the pattern defining a plurality of riblets; sealing a vacuum bagging film over the fiber material arranged in the mold to form a chamber; applying a resin material to the fiber material arranged in the mold; applying a force to the chamber in which the fiber material and the resin material are received; and compacting the fiber material and the resin material in the chamber in response to application of the force such that the plurality of riblets are integrally formed in the resin material of the composite material component.

In some aspects, the techniques described herein relate to a method, wherein applying the resin material includes injecting the resin material into the chamber after sealing the vacuum bagging film over the fiber material arranged in the mold.

In some aspects, the techniques described herein relate to a method, wherein applying the resin material includes applying the resin material to the fiber material received in the mold prior to sealing the vacuum bagging film over the fiber material arranged in the mold.

In some aspects, the techniques described herein relate to a method, wherein applying the force includes applying a vacuum force, and further including: drawing air out of the chamber and compacting the fiber material and the resin material received in the chamber in response to application of the vacuum force.

In some aspects, the techniques described herein relate to a method, wherein the mold includes a first mold having a first pattern formed therein, and a second mold having a second pattern formed therein, and wherein applying the force includes applying a compacting force that forces the second mold toward the first mold, and forces the second pattern into a corresponding surface of the resin material.

In some aspects, the techniques described herein relate to a method, further including: applying heat to the fiber material and the resin material in the chamber; and curing the resin material in response to application of the heat.

In some aspects, the techniques described herein relate to a composite material component for an aircraft, including: a resin material; fiber materials arranged in the resin material; and a plurality of riblets integrally formed in an external surface of the resin material, the external surface defining an aerodynamic surface of a skin portion of the aircraft.

In some aspects, the techniques described herein relate to a composite material component, wherein the plurality of riblets are aligned with an airflow direction of the aerodynamic surface of the composite material component.

In some aspects, the techniques described herein relate to a composite material component, wherein the composite material component forms at least at portion of one of a fuselage portion of the aircraft, a wing portion of the aircraft, a nacelle portion of the aircraft, or a stability and control portion of the aircraft.

### BRIEF DESCRIPTION OF THE DRAWINGS

FIG. 1A is a front perspective view, and FIG. 1B is a rear perspective view, of an example aircraft.

FIG. 1C is a top view of the example aircraft shown in FIGS. 1A and 1B.

FIG. 1D is a side view of the example aircraft shown in FIGS. 1A-1C.

FIG. 2A is a perspective view of an example composite material component including an example drag reduction feature incorporated into a surface of the example composite material component, in accordance with implementations described herein.

FIG. 2B is a cross-sectional view of the example composite material component, taken along line A-A of FIG. 2A.

FIG. 2C is a close-in view of a portion B shown in FIG. 2B.

FIG. 2D is a close-in view of a portion C shown in FIG. 2C.

FIGS. 3A-3D illustrate example drag reduction features incorporated into a surface of a composite material component.

FIGS. 4A and 4B are schematic illustrations of a vacuum bag molding apparatus.

FIGS. 5A and 5B are schematic illustrations of a vacuum bag molding apparatus.

FIGS. 6A and 6B are schematic illustrations of a vacuum bag molding apparatus.

FIG. 7 is a schematic illustration of a resin transfer molding apparatus.

FIG. 8 is a flowchart of an example method, in accordance with implementations described herein.

The above figures are provided to illustrate features and concepts to be described herein, and are not necessarily drawn to scale.

### DETAILED DESCRIPTION

Hereinafter, systems and methods, in accordance with implementations described herein, will be described with respect to incorporation of drag reduction features into example composite material components. Numerous examples are presented in the form of composite material components of example aircraft, simply for purposes of discussion and illustration. The principles to be described herein are applicable to other types of composite material components, to be used in other applications, objects, vehicles, and the like for which the reduction of drag would be beneficial.

Efficiency during operation of a vehicle that passes through a fluid medium, such as, for example, a watercraft through water, an aircraft through air, and the like, can be affected by numerous different factors including, for example, form/profile of the vehicle, drag/drag coefficient, weight, environmental conditions, and other such factors. The effect of these factors can be amplified, or exacerbated, during certain operation of the vehicle. For example, the effect of these factors can be amplified or exacerbated for an aircraft at high-speed cruise conditions, including supersonic cruise conditions, particularly over relatively long ranges. The incorporation of drag reduction features into the vehicle, for example, an aircraft (both supersonic aircraft and subsonic aircraft) may improve efficiency, particularly during long range cruise operation of the aircraft.

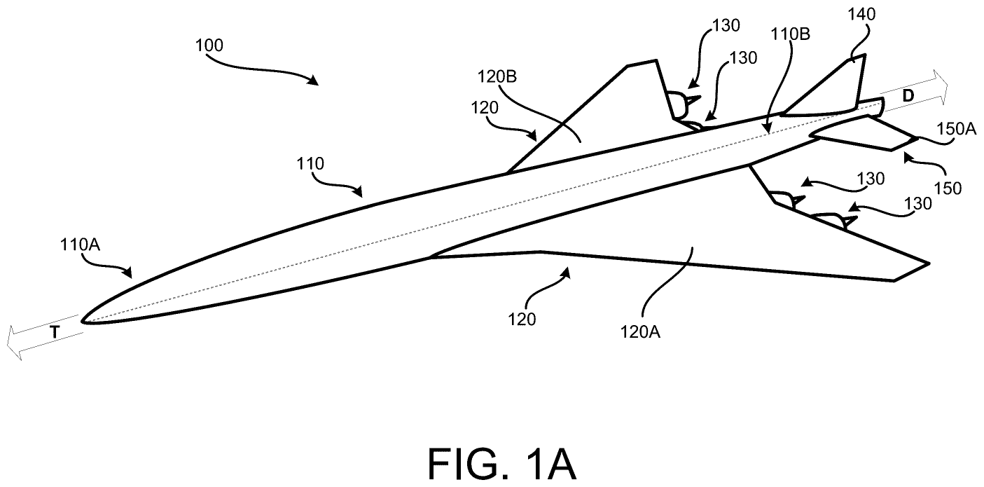

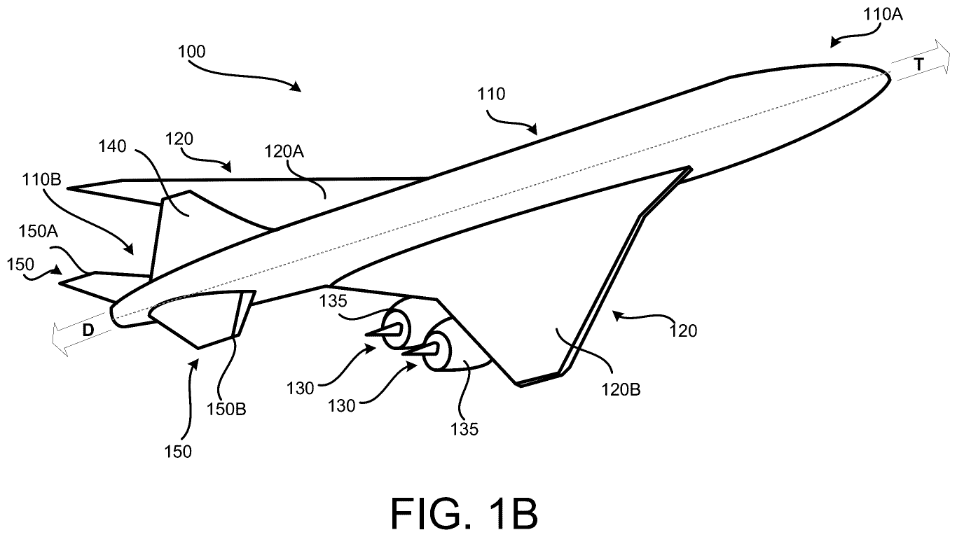

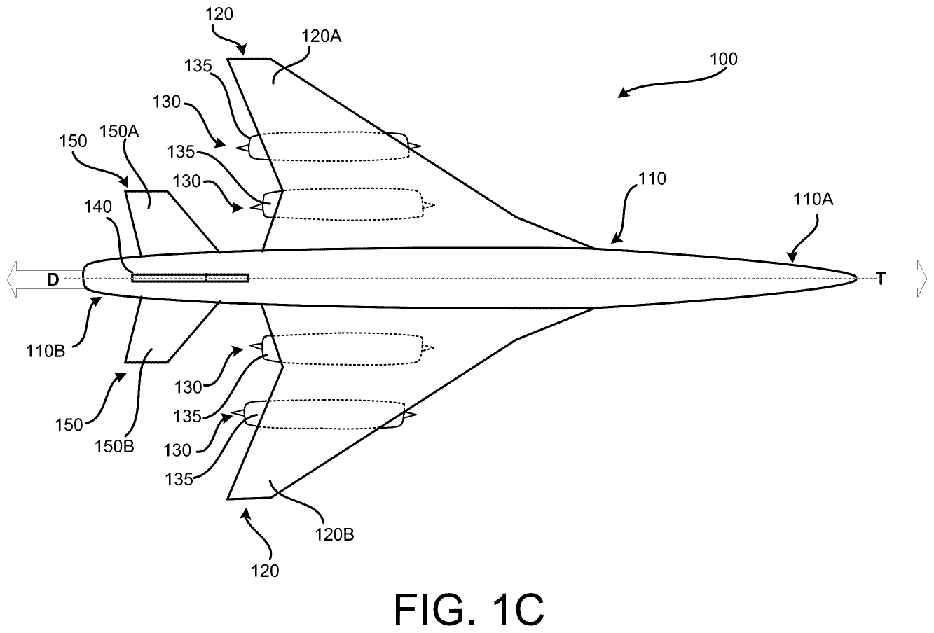

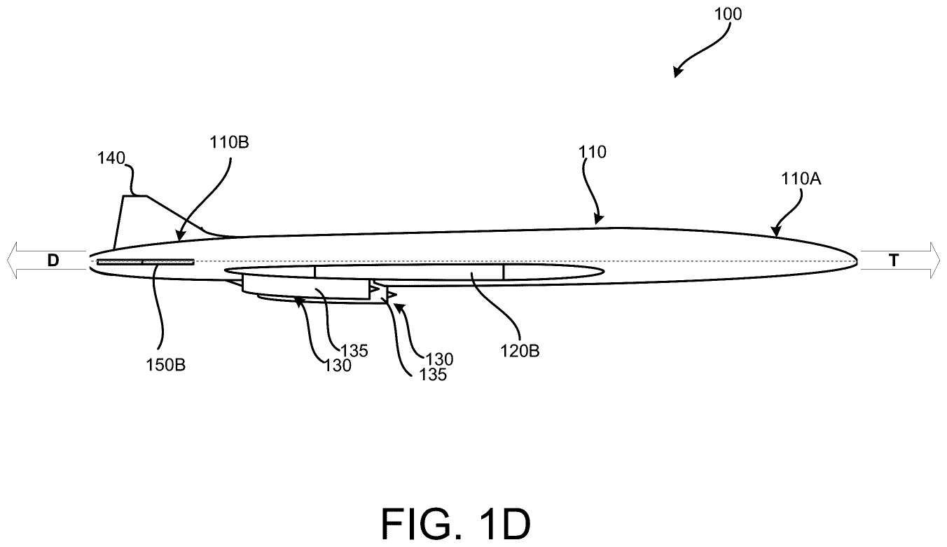

FIGS. 1A-1D present various views of an example aircraft 100 in which drag reduction features, in accordance with implementations described herein, may be incorporated. In particular, FIG. 1A is a front perspective view, FIG. 1B is a rear perspective view, FIG. 1C is a top view, and FIG. 1D is a side view, of the example aircraft 100. The example aircraft 100 shown in FIGS. 1A-1D is provided simply for purposes of discussion and illustration. The principles to be described herein are applicable to other types of vehicles that would benefit from the incorporation of drag reduction features, and/or other types of aircraft, having other configurations, and/or including other features and/or combinations of features arranged similarly to or differently from what is explicitly shown in FIGS. 1A-1D.

The example aircraft 100 is defined by an aircraft structure, or an aircraft body. The structure, or body, of the example aircraft 100 includes a main body, or a fuselage 110, extending from a forward end portion 110A to an aft end portion 110B. The structure, or body, of the example aircraft 100 includes a pair of wings 120, including a first wing 120A on a first side portion of the fuselage 110, and a second wing 120B on a second side portion of the fuselage 110. In the example arrangement shown in FIGS. 1A-1D, the wings 120 have a delta configuration and are mounted at an intermediate portion of the structure of the example aircraft 100, simply for purposes of discussion and illustration.

In the example arrangement shown in FIGS. 1A-1D, a propulsion system is mounted to the structure, or body, of the aircraft 100. In the example shown in FIGS. 1A-1D, the propulsion system includes a plurality of engines 130 mounted within nacelles 135 on the wings 120. The example arrangement shown in FIGS. 1A-1D includes four engines 130 symmetrically arranged about a longitudinal centerline of the example aircraft 100, with two engines 130 mounted on the first wing 120A, and two engines 130 mounted on the second wing 120B, simply for purposes of discussion and illustration. The principles to be described herein are applicable to aircraft including more, or fewer engines 130, mounted differently, for example, at different portions of the structure defining the aircraft 100.

The example aircraft 100 includes a plurality of stability and control devices provided at the aft end portion 110B of the aircraft 100. In the example arrangement shown in FIGS. 1A-1D, the plurality of stability and control devices includes a vertical tail 140 and a horizontal tail 150. In this example arrangement, the horizontal tail 150 includes a first horizontal tail portion 150A on the first side portion of the fuselage 110, aft of the first wing 120A, and a second horizontal tail portion 150B on the second side portion of the fuselage 110, aft of the second wing 120B. The aircraft 100 can include other types of stability and control devices, provided at other portions of the structure of the aircraft 100. The example aircraft 100 and plurality of engines 130 may be designed to operate at both low speed/subsonic flight conditions, and at high speed flight conditions including supersonic flight conditions.

In general, drag may be associated with a rearward, retarding force exerted on a vehicle moving through a fluid. In the example shown in FIGS. 1A-1D, a drag force is exerted on the aircraft 100 in the direction of the arrow D. Drag is typically generated in response to a disruption of fluid surrounding the vehicle due to the profile (i.e., the fluid-dynamic profile of the vehicle that disrupts the flow of fluid medium surrounding the vehicle), portions of the vehicle extending into the fluid flow, and the like. In the example shown in FIGS. 1A-1D, drag may be generated in response to a disruption of the flow of air surrounding the example aircraft 100, due to, for example, the aerodynamic profile of the fuselage 110, the wings 120, the stability and control devices (including the vertical tail 140, the horizontal tail 150, and other stability and control devices), the engines 130/nacelles 135, and other objects that protrude into the airflow through which the aircraft 100 travels. To achieve forward movement of the aircraft 100, drag forces (exerted in the direction of the arrow D) are overcome by thrust forces produced by the one or more engines 130, exerted in the direction of the arrow T. In general, forward movement of the aircraft 100 is generated based on a differential between the magnitude of the thrust generated by the engines 130 compared to the magnitude of drag to be overcome.

Drag reduction features, in accordance with implementations described herein, may reduce the drag forces associated with operation of a vehicle moving through a fluid medium. In the case of an aircraft, reductions in drag forces during operation of the aircraft may, in turn, produce reductions in thrust required to produce a desired speed of the aircraft in a particular flight condition. A reduction in the thrust required to produce the desired speed may, in turn, reduce an amount of fuel consumed in generating the thrust required to produce the desired speed. Thus, the aircraft may consume a reduced amount of fuel for a flight having a given range, without compromising speed for that flight and/or increasing travel time/duration of that flight. Reduced fuel consumption may allow the aircraft to carry less fuel for a given flight, thus reducing weight, and further improving fuel efficiency. Reduced fuel consumption may provide for longer range flights for a given fuel carrying/storage capacity, or fuel payload, of the aircraft, thus enhancing utility of the aircraft. In some situations, reduced fuel consumption may allow for a reduction in the internal volume of the aircraft that is allocated for fuel storage. This may allow for changes in the aerodynamic profile of the aircraft that may further enhance operational efficiency, and/or may allow that internal volume to be re-allocated for passenger use and/or payload and/or to accommodate other aircraft systems, thus further enhancing utility of the aircraft. Incorporation of drag reduction features is presented with respect to an example aircraft, simply for purposes of discussion and illustration. The principles to be described herein are applicable to any type of vehicle for which such features may be beneficial.

In some implementations, the drag reduction features include a plurality of features incorporated into the outer skin surface of one or more components of the vehicle. In some examples, the one or more features includes a plurality of riblets incorporated in a composite material forming the outer skin surface of at least a portion of the vehicle. In some examples, the plurality of riblets are integrally formed in the composite material, such that the plurality of riblets are a substantially continuous extension of the outer skin surface of the one or more components made of the composite material. Integral formation of the plurality of riblets into the composite material forming the outer skin surface provide for interaction of the plurality of riblets with the fluid media surrounding the vehicle.

In some examples, at least some portions of a skin portion of an aircraft, such as the example aircraft 100 described above, or other aircraft not explicitly described herein, may be made of composite materials. Composite materials typically exhibit superior strength characteristics, or strength to weight characteristics, when compared to that of other materials typically used in these types of aircraft applications, including metal materials such as aluminum. Thus, the use of composite materials may provide desired tensile and compressive strength at a reduced weight, with the reduced weight again providing operational cost savings in the form of, for example, reduced fuel consumption, greater and/or reallocated payload space, greater range, and the like. Composite materials may also exhibit improved resistance to environmental degradation, thus improving reliability and reducing operational costs associated with maintenance. In some examples, the fabrication of portions of the aircraft having relatively complex geometry may be facilitated through the use of composite materials, thus providing greater flexibility in the optimization of aerodynamic profile of the aircraft and the like. In some examples, composite materials may provide superior heat resistance when compared to traditional materials including metal materials such as aluminum. These characteristics may make the use of composite materials particularly advantageous in aircraft equipped for high speed operation, for example, supersonic aircraft, which may experience relatively high outer surface temperatures due to skin friction with the atmosphere during supersonic flight.

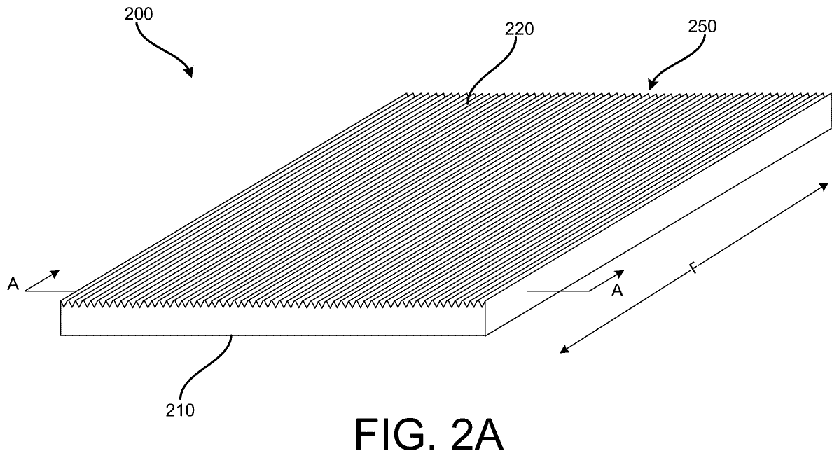

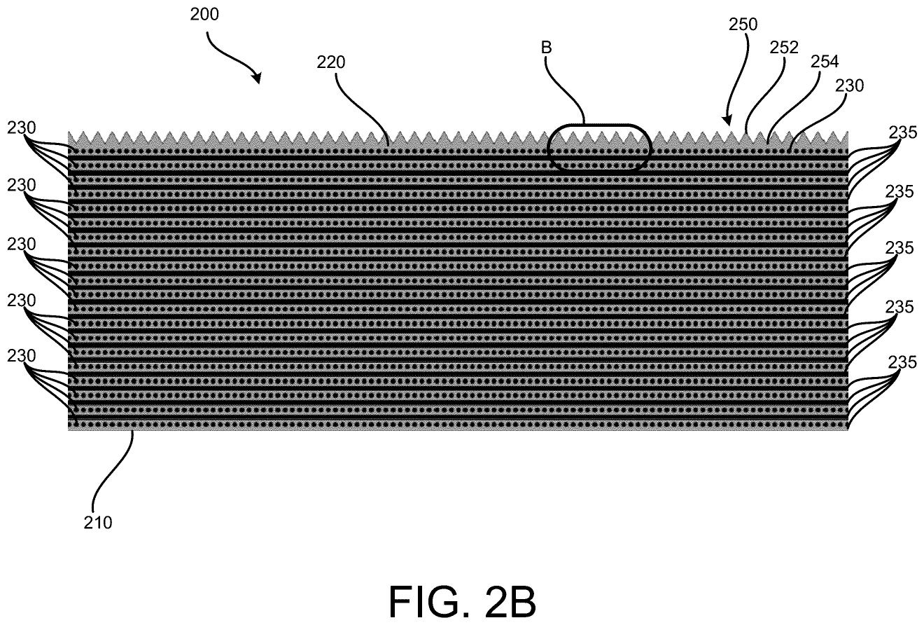

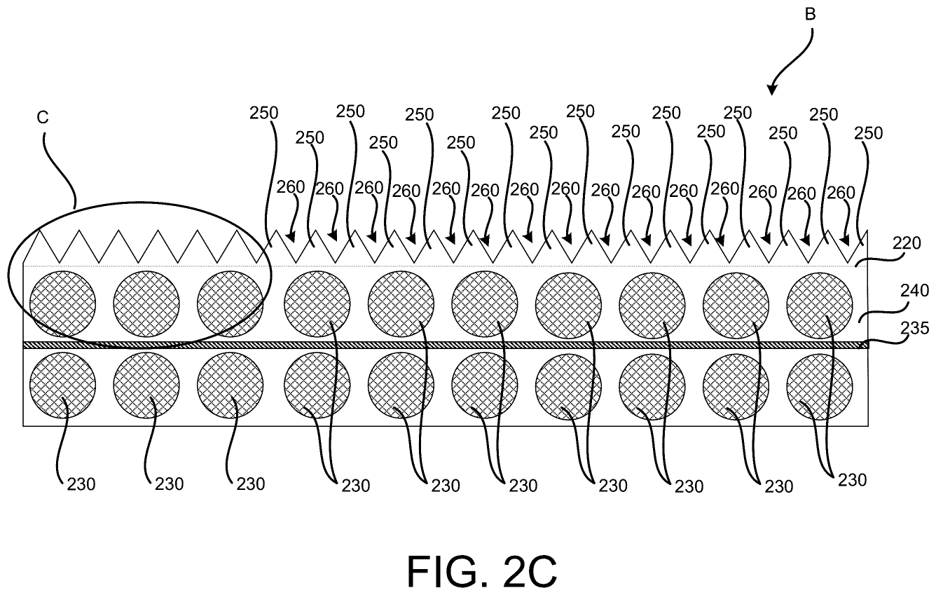

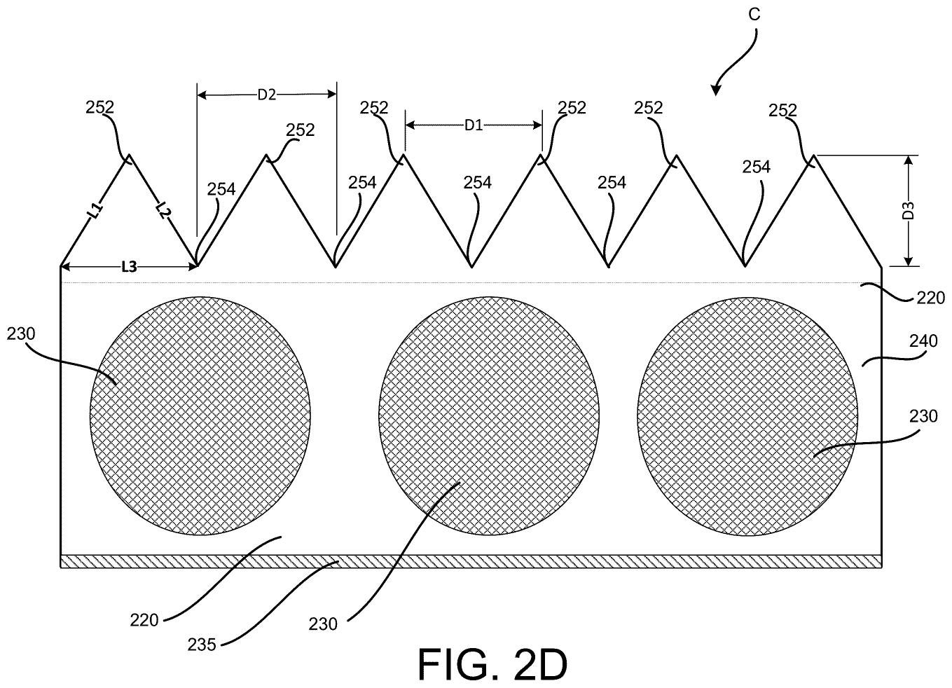

FIG. 2A illustrates an example section of material. The example section of material shown in FIG. 2A may be representative of a skin portion of the example aircraft 100 described above with respect to FIGS. 1A-1D, or another application not specifically described herein. The example section of material shown in FIG. 2A illustrates the incorporation of example drag reduction features, in accordance with implementations described herein, into a composite material component. The example drag reduction features are shown in more detail in FIGS. 2B, 2C and 2D. In particular, FIG. 2B is a cross-sectional view of the example section of composite material, taken along line A-A of FIG. 2A. FIG. 2C provides a close-in view of a portion B shown in FIG. 2B. FIG. 2D provides a close in view of a portion C shown in FIG. 2C. The views shown in FIGS. 2A-2C are provided for purposes of discussion and illustration, and the features depicted therein are not necessarily to scale.

The example section of material shown in FIG. 2A may be illustrative of a portion of the wetted area of the example aircraft 100, representing a portion of the aircraft 100 that interacts with the fluid medium surrounding the vehicle. The example section of material may be representative of a portion of the skin of, for example, the fuselage 110 and/or the wings 120 and/or the nacelles 135 and/or the vertical tail 140 and/or the horizontal tail 150, and/or other portions of the outer skin of the structure of the example aircraft 100 not specifically described. In particular, the example section of material shown in FIG. 2A may be illustrative of a skin portion of the example aircraft 100 that is made of a composite material including the example drag reduction features, in accordance with implementations described herein. In particular, the example section of material may be illustrative of a skin portion of the example aircraft 100 that is made of a composite material, and that has the example drag reduction features integrally formed into an outer surface of the composite material.

The example section of material shown in FIG. 2A may represent a portion or section of a composite material component 200. The example composite material component 200 may be a component of any number of vehicles for which the incorporation of drag reduction features may be beneficial. In this example, the composite material component 200 is presented in the form of a sheet, or a panel, or a layer. In this example, the composite material component 200 has a first surface 210 configured to be oriented toward an interior portion of the aircraft 100, and a second surface 220 configured to be oriented toward an exterior of the aircraft 100. The second surface 220 may define an outward facing, aerodynamic surface of the skin of the aircraft 100. The second surface 220 may be exposed to the boundary layer developed due to the external airflow along the second surface 220 of the composite material component 200 during operation of the aircraft 100. In the example shown in FIG. 2A, an example drag reduction feature, in the form of a plurality of riblets 250, is incorporated into the second surface 220 of the composite material component 200. The plurality of riblets 250 may be defined by a respective plurality of protrusions formed in the second surface 220, with the plurality of riblets 250 defining a plurality of grooves 260 formed between adjacent riblets 250.

In some examples, the plurality of riblets 250 (and the plurality of grooves 260 defined between respective pairs of adjacent riblets 250) are formed in the aerodynamic surface of the skin of the aircraft 100. In some examples, the plurality of riblets 250 are arranged on the surface of the skin of the aircraft 100, aligned with a direction of the flow of fluid (i.e., air) along the skin of the aircraft 100. When formed in the outer, aerodynamic surface of the skin of the aircraft 100, the plurality of riblets 250 including the plurality of grooves 260 defined respectively therebetween may be exposed to boundary layer flow along the outer surface of the aircraft 100, and in some situations, to turbulent boundary layer flow. In some examples, a shape and/or a configuration of the plurality of riblets 250 produces a reduction in flow interaction between portions of the outer skin in which the riblets 250 are formed and turbulent portions of the boundary layer, thus reducing skin friction and shear stresses experienced at the outer skin of the aircraft 100. The reduction in skin friction/shear stresses in turn produces a reduction in skin drag, or skin friction drag, and thus overall drag, during operation of the aircraft 100.

As shown in more detail in FIGS. 2B-2D, in some examples the composite material component 200 may include a plurality of fibers 230 arranged in a resin material 240. In some examples, the plurality of fibers 230 extend in a longitudinal direction F of the composite material component 200. In some examples, the plurality of fibers are arranged in rows in the resin material 240. In some examples, the composite material component 200 includes one or more sheets 235 of fiber material, in addition to or instead of the plurality of fibers 230. In some examples, one or more sheets 235 of fiber material are arranged between one or more adjacent rows of the fibers 230 extending longitudinally in the composite material component 200.

In the example shown in FIGS. 2A-2D, the plurality of fibers 230 and/or the sheets 235 of fiber material have substantially the same cross-sectional size and shape, simply for purposes of discussion and illustration. In the example shown in FIGS. 2A-2D, the plurality of fibers 230 and/or the sheets 235 of fiber material are arranged substantially equidistantly, at substantially uniform intervals within the resin material 240, simply for purposes of discussion and illustration. The principles to be described herein are applicable to a composite material including fibers and/or sheets of fiber material having different shapes and/or cross-sectional dimensions and/or combinations thereof, arranged similarly or differently than shown.

The plurality of riblets 250 are formed in the second surface 220, i.e., the outward facing surface, or the aerodynamic surface, of the composite material component 200. In the example shown in FIGS. 2A-2D, each of the riblets 250 has a substantially triangular cross-sectional shape, including a first side surface having a first length L1, a second side surface having a second length L2, and a third side surface (i.e., the base, in the example orientation shown in FIGS. 2A-2D) having a third length L3. In some examples, the cross-sectional shape of each of the riblets 250 is defined by an equilateral triangle, in which the first length L1 is substantially equal to the second length L2, and is substantially equal to the third length L3. In the example shown in FIGS. 2A-2D, a cross-sectional size and a cross-sectional shape of each of the riblets 250 is substantially the same, with a distance D1 between adjacent peaks 252, a distance D2 between adjacent troughs 254, and a distance D3 from the base to the corresponding peak 252 (i.e., a height) of each of the plurality of riblets 250 being substantially uniform along the second surface 220 of the composite material component 200.

In some examples, the cross-sectional size and/or the cross-sectional shape of any one or more of the plurality of riblets 250 may be substantially uniform along the longitudinal direction F of the section of the composite material component 200. Thus, in some examples, the longitudinal profile of each of the plurality of riblets may be substantially uniform along the section of the composite material component along which the riblets 250 are formed. In some examples, the cross-sectional size and/or the cross-sectional shape of any one or more of the plurality of riblets 250 may vary along the longitudinal direction F of the section of composite material component 200. Thus, in some examples, the longitudinal profile of each of the plurality of riblets may vary along the section of the composite material component along which the riblets 250 are formed. In some examples, a configuration (i.e., a cross-sectional size and/or a cross-sectional shape) and/or an arrangement of the plurality of riblets 250 on the second surface 220 of the composite material component 200 may vary based on, for example, a shape or contour of the portion of the outer skin of the aircraft 100 in which the section of composite material is to be used, airflow conditions to which the plurality of riblets 250 will be subjected, material properties of the resin material 240 and/or the fibers 230/sheets 235 of fiber material, and other such factors. Similarly, uniformity and/or variation in the cross-sectional size and/or the cross-sectional shape of adjacent riblets and corresponding longitudinal profile(s) may be determined based on, for example, a shape or contour of the portion of the outer skin of the aircraft 100 in which the section of composite material is to be used, airflow conditions to which the plurality of riblets 250 will be subjected, material properties of the resin material 240 and/or the fibers 230/sheets 235 of fiber material, and other such factors.

In some examples, the plurality of riblets 250 extend substantially in parallel to each other along the longitudinal direction F of the surface of the composite material component 200. In some examples, subsets of the plurality of riblets 250 extend in parallel to each other along the longitudinal direction F. In some examples, some of the plurality of riblets 250 extend substantially in parallel to each other, and some of the plurality of riblets 250 are orientated in a non-parallel manner. In some examples, the plurality of riblets 250 conform to a contour of the surface of the composite material component 200.

In some examples, a size and/or a configuration and/or an orientation of the plurality of riblets 250 may be selected based on, for example, cruise conditions associated with operation of the aircraft 100, configuration of the aircraft 100, drag characteristics of the aircraft 100, and other such features and/or factors. For example, in a supersonic application, a cross-sectional size and/or a cross-sectional shape and/or an arrangement of the plurality of riblets 250 and/or a placement position of the plurality of riblets 250 on the outer skin of the aircraft 100 may be selected to derive the greatest reduction in drag during supersonic cruise conditions, where the most benefit will be derived. Similarly, in an aircraft designed for primarily subsonic operation, a cross-sectional size and/or a cross-sectional shape and/or an arrangement of the plurality of riblets 250 and/or a placement position of the plurality of riblets 250 on the outer skin of the aircraft 100 may be selected to derive the greatest reduction in drag during sustained cruise conditions.

In some examples, the plurality of riblets 250 may be fabricated so as to obtain, and maintain, relatively sharp peaks 252 and/or relatively sharp troughs 254, as in the example V-shaped plurality of riblets 250 shown in FIGS. 2A-2D. That is, in some examples, the plurality of riblets 250 are fabricated such that a relatively sharp corner is obtained, and maintained over the course of operation of the aircraft 100, at the peak 252 formed at the transition, or point of intersection, between the first side surface and the second side surface of each riblet 250. Said differently, an acute angle may be formed at the peak 252, where the first side surface intersects the second side surface of each riblet 250. The peak 252 may form a ridge that extends longitudinally, along the longitudinal length of the riblet 250. Similarly, in some examples, the plurality of riblets 250 are fabricated such that a relatively sharp corner is obtained, and maintained over the course of operation of the aircraft 100, at the trough 254 formed at the transition, or point of intersection between, the second side surface of one riblet 250 and the first side surface of an adjacent second riblet 250. Said differently, an acute angle may be formed at the trough 254, where the second side surface of one riblet 250 intersects the first side surface of an adjacent second riblet 250. Obtaining, and maintaining, sharp peaks 252 and/or troughs 254 may allow the plurality of riblets 250 to obtain, and maintain, effectiveness and achieve the desired drag reduction. That is, in some examples, the sharp corners formed at the peaks 252 and troughs 254 of the riblets 250 may work to reduce interaction of the second surface 220 of the composite material component 200 with the turbulent boundary layer, to thus reduce skin drag, or skin friction drag, and thus overall drag, associated with an aircraft component incorporating the plurality of riblets 250.

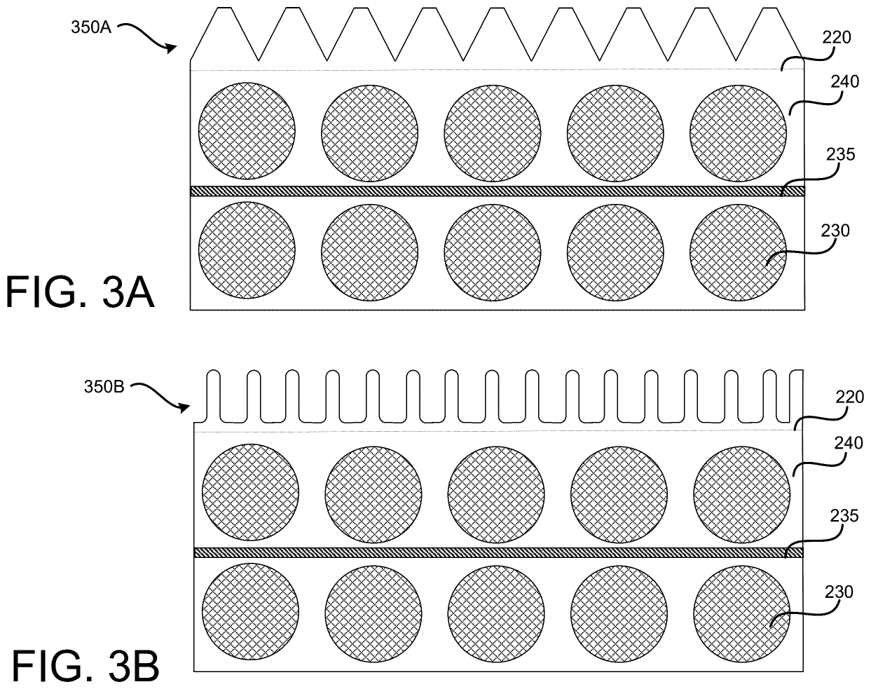

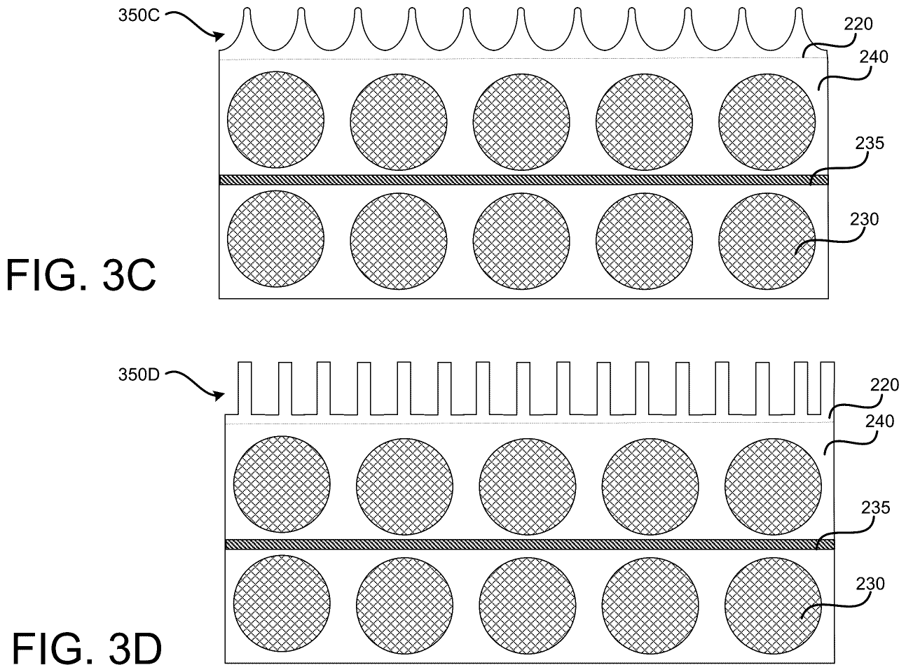

As noted above, the example configuration and arrangement of the plurality of riblets 250 and grooves 260 formed therebetween is provided in FIGS. 2A-2D for purposes of discussion and illustration. The principles to be described herein are applicable to riblets and grooves having other configurations and/or arrangements and/or combinations thereof on an outer skin surface of a composite material. FIGS. 3A-3D illustrate other example configurations and arrangements of riblets 350A, 350B, 350C and 350D, respectively. Principles described herein are not limited to the configurations and/or arrangements explicitly shown.

Additionally, as noted above, the example riblets and grooves are described above with respect to incorporation into an aircraft, for example, at least some portion of the wetted area of the aircraft, simply for purposes of discussion and illustration. The principles described herein are applicable not only to the subsonic and supersonic operation of aircraft, but also to the operation of other types of vehicles, including air vehicles, land vehicles, and water borne vehicles, to reduce drag and enhance operational performance.

As noted above, the relatively high strength to weight ratio, adaptability to fabrication in complex geometries, thermal tolerances, and other such characteristics make composite materials desirable for use in aircraft. These characteristics make the use of composite materials particularly desirable for use in high speed/supersonic aircraft, where the use of composite material components can help achieve greater efficiency during long range cruise conditions. When using composite materials to form some or all of the outer skin of such an aircraft, drag reduction features, such as the example riblets described above, may be incorporated into the outer surface of the composite material, to provide for drag reduction during operation of the aircraft. This may further enhance efficiency, during operation of all types of aircraft, and particularly during high speed/supersonic flight conditions, and particularly over the relatively long ranges for which high speed/supersonic flight is employed.

Accordingly, incorporation of drag reduction features, such as the example riblets described above, may involve incorporating the drag reduction features into a composite material forming a fluid-dynamic surface of the vehicle that interacts with the surrounding fluid medium. Incorporation of drag reduction features, such as the example riblets described above, into a high speed/supersonic aircraft may involve incorporating the drag reduction features into an outer facing surface of a composite material forming the outer skin of the aircraft. Factors such as, for example, environmental conditions associated with high speed/supersonic operation, properties of the resin material, and the like, may render some modes of incorporation of these types of drag reduction features into the composite material impractical. For example, skin temperatures experienced by this type of aircraft, particularly during high speed/supersonic flight conditions, may preclude the application of a separate surface layer including the drag reduction features to the outer surface of the composite material post-fabrication. That is, the relatively high skin temperatures experienced during high speed/supersonic flight may compromise adhesion of such a surface layer, thus rendering the drag reduction features ineffective, and posing a hazard due to potential separation. Machining or etching these types of drag reduction features into the outer surface of the composite material post-fabrication may produce imprecise and/or inconsistent features and/or may have an adverse impact on the integrity of the composite material.

A system and method, in accordance with implementations described herein, provides for the incorporation of drag reduction features into a composite material component, such that the drag reduction features are integrally formed in the composite material. Hereinafter, examples are directed to the incorporation of the drag reduction features into a composite material component of forming an outer skin of an aircraft, simply for purposes of discussion and illustration. The principles to be described are applicable to the incorporation of features into the surface of composite material components for other applications. In some examples, the drag reduction features include a plurality of grooves integrally formed in the composite material. In some examples the plurality of grooves are defined by a plurality of riblets formed in a surface of the composite material corresponding to the outer skin of the aircraft. In some examples, the drag reduction features are formed into the composite material during a molding process for fabrication of the component forming the skin portion of the aircraft. In some examples, the molding process for fabrication of the component includes a compression molding process and/or a thermal molding process. In some examples, the molding process includes a vacuum bagging molding process. In some examples, the compression molding process includes a resin transfer molding process.

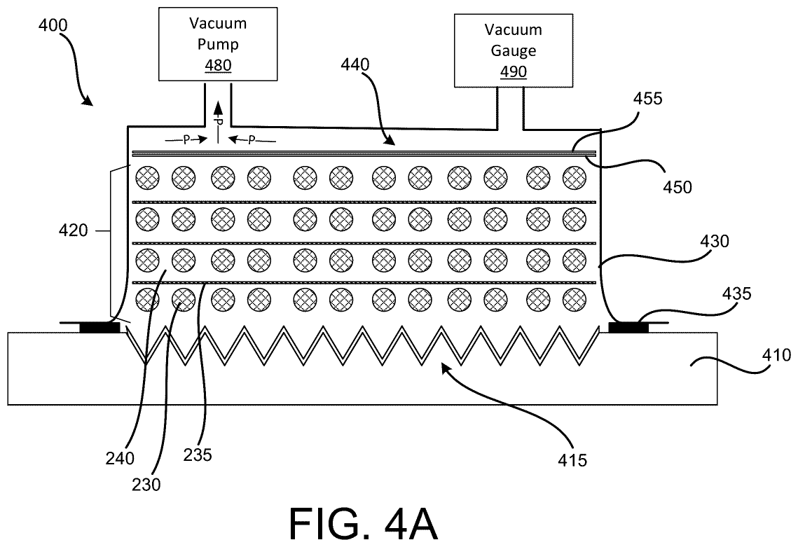

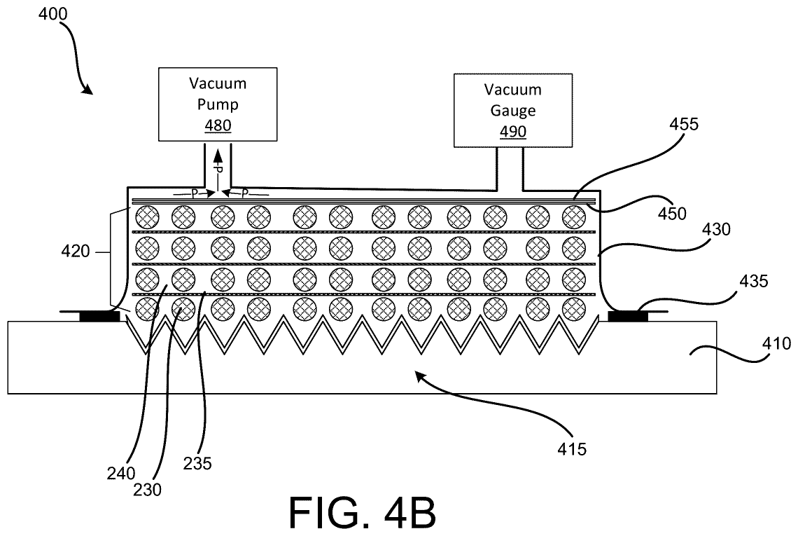

FIGS. 4A and 4B are schematic diagrams illustrating example operation of an example vacuum bag molding apparatus 400, for fabrication of a composite material component including drag reduction features, in accordance with implementations described herein. The example vacuum bag molding apparatus 400 includes a mold 410, with a pattern 415 formed in a molding surface of the mold 410. In this example, a configuration, or shape, or contour, of the pattern 415 defined in the mold 410 corresponds to the configuration and/or shape and/or contour of the drag reduction features to be integrally incorporated into the composite material component. For example, a configuration, or shape, or contour of the pattern 415 may correspond to the configuration and/or shape and/or contour of the plurality of riblets 250 to be formed in the aerodynamic surface of the example composite material component 200 as described above. In some examples, the mold 410 is made of a rigid material that can maintain the example configuration, or shape, or contour of the pattern 415, under pressure applied to the mold 410 during fabrication of the example composite material component 200.

In the example arrangement shown in FIG. 4A, materials 420 are laid, for example, sequentially laid, in the mold 410. In the example shown in FIG. 4A, the example layup of materials 420 includes the example plurality of fibers 230 and/or sheets 235 of fiber material, layered in the resin material 240 (only one of which is labeled in FIG. 4A; see FIGS. 2B-2D for more detail). A vacuum bag, or vacuum bagging film 430, is positioned surrounding the layup of materials 420. A seal 435 extends along a peripheral portion of the layup of materials 420, between a peripheral portion of the vacuum bagging film 430 and a corresponding portion of the mold 410, so as to define a vacuum chamber 440 in which the layup of materials 420 is received. In some examples, additional layers including, for example, one or more release films 450, one or more absorption films 455, and other such layers, may be positioned on the layup of materials 420, for example, at one or both ends of the layup of materials 420, to facilitate the pressurization of the vacuum chamber 440 and/or the removal of the completed component from the vacuum bag molding apparatus 400. In the example arrangement shown in FIGS. 4A and 4B, a vacuum pump 480 is actuated, to exert a vacuum force that draws a vacuum on the fibers 230/sheets 235 of fiber materials and resin material 240 received in the chamber 440. The vacuum force may allow the resin material 240 to more fully permeate the fibers 230 and/or the sheets 235 of fiber material, while drawing air out of the chamber 440 in the direction of the arrows P. In some examples, air may be drawn out of the chamber 440 in this manner until voids in the resin material 240 are substantially eliminated and a desired level of compaction in the layup of materials 420 is achieved, as shown in FIG. 4B. In some examples, a vacuum pressure in the chamber 440 may be measured by a vacuum gauge 490 to detect when the desired level of compaction of the layup of materials 420 has been achieved.

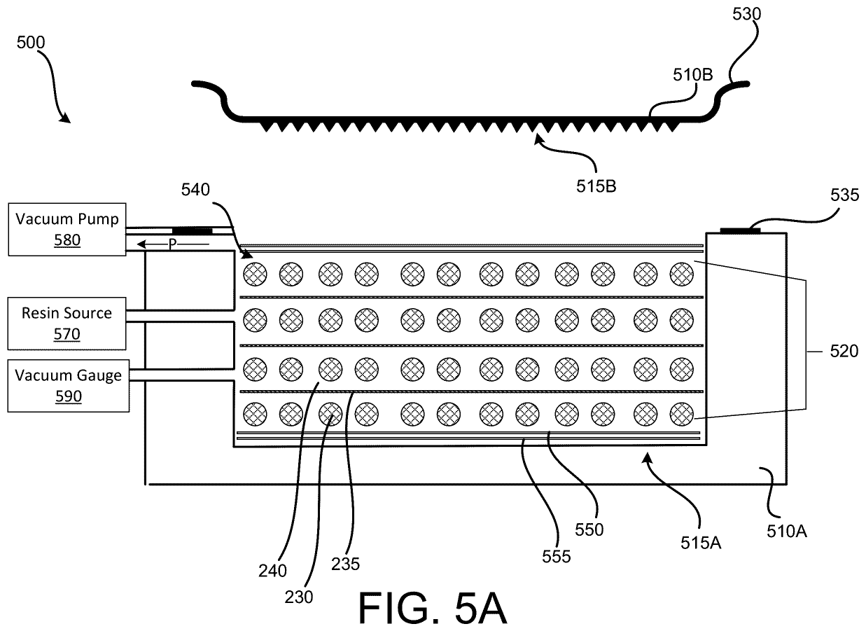

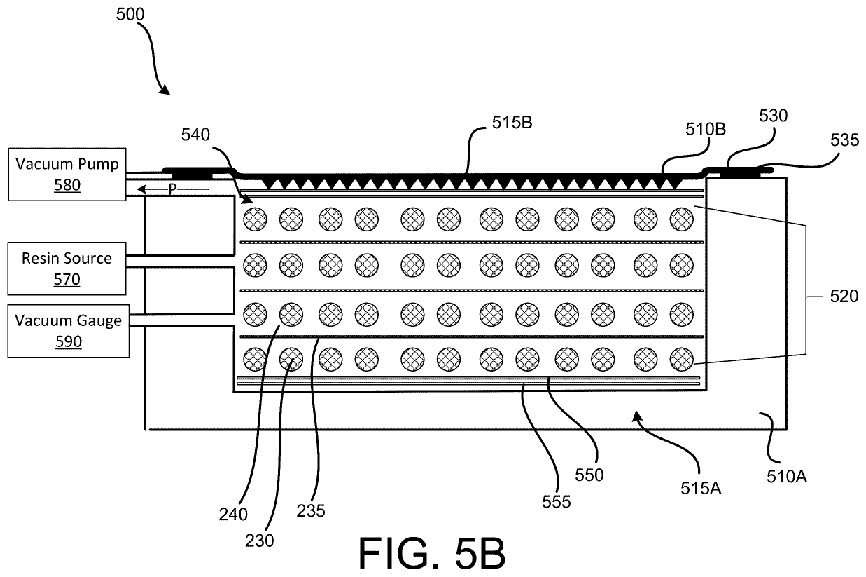

FIGS. 5A and 5B are schematic diagrams illustrating example operation of an example vacuum bag molding apparatus 500, for fabrication of a composite material component including drag reduction features, in accordance with implementations described herein. The example vacuum bag molding apparatus 500 includes a first mold 510A, with first pattern 515A formed in a molding surface of the first mold 510A. In the example shown in FIGS. 5A and 5B, a cross-sectional contour of the first pattern 515A is substantially flat, simply for purposes of discussion and illustration. The example vacuum bag molding apparatus 500 includes a second mold 510B including a second pattern 515B formed in a molding surface of the second mold 510B. In the example arrangement shown in FIGS. 5A and 5B, a configuration, or shape, or contour, of the second pattern 515B defined in the second mold 510B corresponds to the configuration and/or shape and/or contour of the drag reduction features to be integrally incorporated into the composite material component 200. For example, a configuration, or shape, or contour of the second pattern 515B may correspond to the configuration and/or shape and/or contour of the plurality of riblets 250 to be formed in the fluid-dynamic surface of the example composite material component 200 as described above. In some examples, the first mold 510A and/or the second mold 510B is made of a rigid material that can maintain the example, configuration, or shape, or contour of the first pattern 515A and/or the second pattern 515B, under thermal and/or pressure forces applied to the first mold 510A and/or the second mold 510B during fabrication of the example composite material component 200. In the example shown in FIGS. 5A and 5B, the second mold 510B including the second pattern 515B is incorporated into a vacuum bagging film 530 to be positioned on a layup of materials 520 arranged in the first mold 510A.

As shown in FIG. 5A, materials 520 may be laid, for example, sequentially laid, in the first mold 510A. In the example shown in FIG. 5A, the example layup of materials 520 includes the example plurality of fibers 230 and/or sheets 235 of fiber material, layered in the resin material 240 (only one of which is labeled in FIG. 5A; see FIGS. 2B-2D for more detail). A vacuum bag, or vacuum bagging film 530 is positioned across exposed portions of the layup of materials 520. A seal 535 extends along a peripheral portion of the layup of materials 520, between a peripheral portion of the vacuum bagging film 530 and a corresponding portion of the first mold 510A, so as to define a vacuum chamber 540 in which the layup of materials 520 is received. In some examples, the resin material 240 is filled into the layup of materials 520 positioned in the chamber 540 from a resin source 570 supplying the resin material 240 into the chamber 540 via an injection port extending through the first mold 510A and into the chamber 540. In some examples, the resin material 240 is injected into the chamber 540 in another manner. The resin material 240 may fill voids in the chamber 540 not otherwise occupied by fibers 230 and/or sheets 235 of fiber material. In some examples, the resin material 240 may be applied as the fibers 230/sheets 235 of fiber material are laid. In some examples, additional layers including, for example, one or more release films 550, one or more absorption films 555, and other such layers, may be positioned on the layup of materials 520, for example, at one or both ends of the layup of materials 520, to facilitate the pressurization of the vacuum chamber 540 and/or the removal of the completed component from the vacuum bag molding apparatus 500.

In the example arrangement shown in FIGS. 5A and 5B, the vacuum bagging film 530 including the second pattern 515B is lowered onto the exposed surface of the layup of materials 520 received in the first mold (i.e., downward, in the example orientation shown in FIGS. 5A and 5B). This positions the second pattern 515B on the exposed surface of the layup of materials 520 prior to initiating a compacting action on the resin material 240. A vacuum pump 580 is actuated, to exert a vacuum force that draws a vacuum on the chamber 540. The vacuum force applied by the vacuum pump 580 may cause the resin material 240 to more fully permeate the fibers 230/sheets 235 of fiber material, and draw air out of the chamber 540 in the direction of the arrow P. The compacting force generated due to the action of the vacuum pump 580 may continue to draw the second mold 510B downward, to continue to force the second pattern 515B into the layup of materials 520, allowing voids in the resin material 240 to continue to be eliminated, and the layup of materials 520 to continue to be compacted. In some examples, air is drawn out of the chamber 540 in this manner until a desired level of compaction in the layup of materials 520 is achieved, and the second pattern 515B generates a complementary pattern in the layup of materials 520, as shown in FIG. 5B. In some examples, a vacuum pressure in the chamber 540 may be measured by a vacuum gauge 590 to detect when the desired level of compaction of the layup of materials 520 has been achieved.

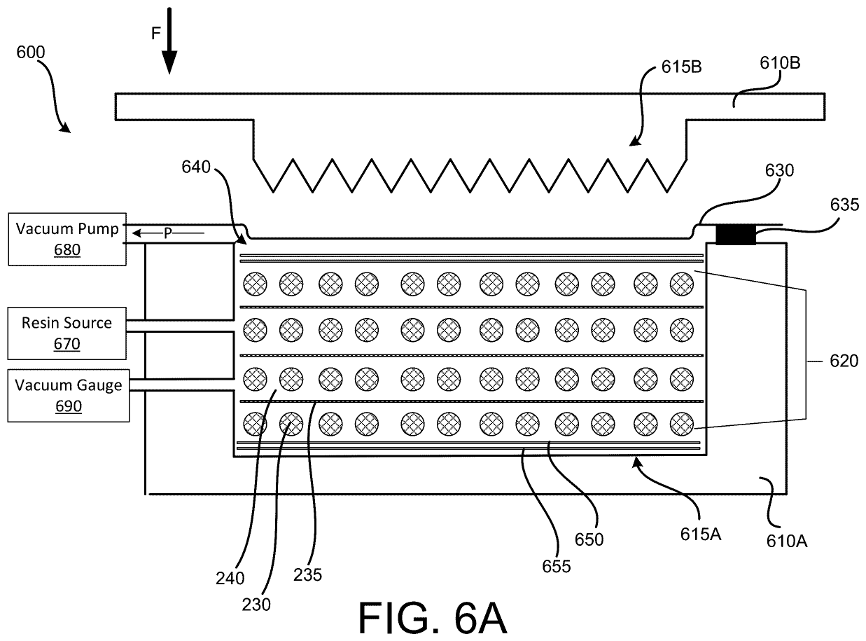

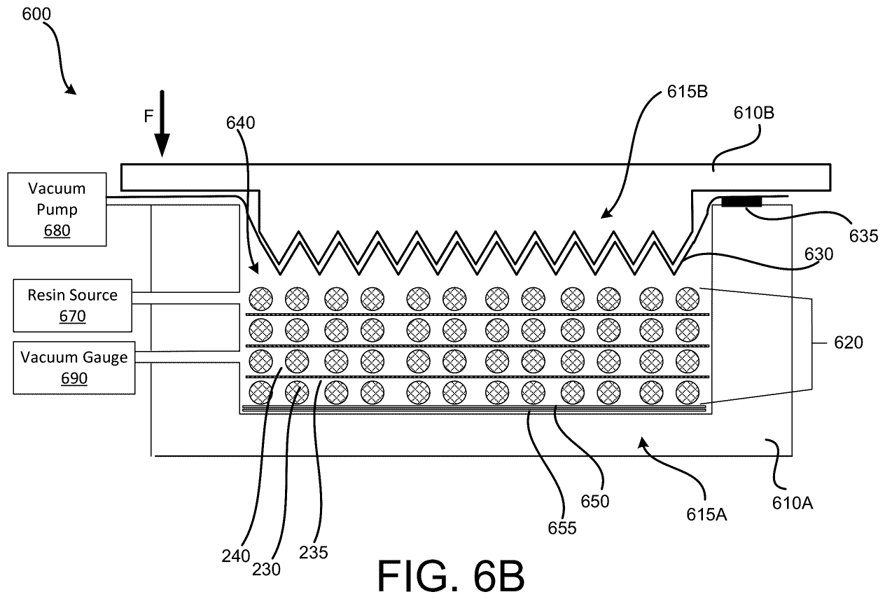

FIGS. 6A and 6B are schematic diagrams illustrating example operation of an example vacuum bag molding apparatus 600, for fabrication of a composite material component including drag reduction features, in accordance with implementations described herein. The example vacuum bag molding apparatus 600 includes a first mold 610A, with first pattern 615A formed in a molding surface of the first mold 610A. In the example shown in FIGS. 6A and 6B, a cross-sectional contour of the first pattern 615A is substantially flat, simply for purposes of discussion and illustration. The example vacuum bag molding apparatus 600 includes a second mold 610B including a second pattern 615B formed in a molding surface of the second mold 610B. In the example arrangement shown in FIGS. 6A and 6B, a configuration, or shape, or contour, of the second pattern 615B defined in the second mold 610B corresponds to the configuration and/or shape and/or contour of the drag reduction features to be integrally incorporated into the composite material component 200. For example, a configuration, or shape, or contour of the second pattern 615B may correspond to the configuration and/or shape and/or contour of the plurality of riblets 250 to be formed in the fluid-dynamic surface of the example composite material component 200 as described above. In some examples, the first mold 610A and/or the second mold 610B is made of a rigid material that can maintain the example, configuration, or shape, or contour of the first pattern 615A and/or the second pattern 615B, under thermal and/or pressure forces applied to the first mold 610A and/or the second mold 610B during fabrication of the example composite material component 200.

As shown in FIG. 6A, materials 620 may be laid, for example, sequentially laid, in the first mold 610A. In the example shown in FIG. 6A, the example layup of materials 620 includes the example plurality of fibers 230 and/or sheets 235 of fiber material, layered in the resin material 240 (only one of which is separately labeled in FIG. 6A; see FIGS. 2B-2D for more detail). A vacuum bag, or vacuum bagging film 630, is positioned across exposed portions of the layup of materials 620. A seal 635 extends along a peripheral portion of the layup of materials 620, between a peripheral portion of the vacuum bagging film 630 and a corresponding portion of the first mold 610A, so as to define a vacuum chamber 640 in which the layup of materials 620 is received. In some examples, the resin material 240 is filled into the layup of materials 620 positioned in the chamber 640 from a resin source 670 supplying the resin material 240 into the chamber 640 via an injection port extending through the first mold 610A and into the chamber 640. In some examples, the resin material 240 is injected into the chamber 640 in another manner. The resin material 240 may fill voids in the chamber 640 not otherwise occupied by fibers 230 and/or sheets 235 of fiber material. In some examples, the resin material 240 may be applied as the fibers 230/sheets 235 of fiber material are laid. In some examples, additional layers including, for example, one or more release films 650, one or more absorption films 655, and other such layers, may be positioned on the layup of materials 620, for example, at one or both ends of the layup of materials 620, to facilitate the pressurization of the vacuum chamber 640 and/or the removal of the completed component from the vacuum bag molding apparatus 600.

A force in the direction of the arrow F (downward, in the example orientation shown in FIGS. 6A and 6B) is exerted on the second mold 610B, to force the second pattern 615B into the layup of materials 620, and a compacting action is initiated on the resin material 240. In some examples, a vacuum pump 680 is actuated, to exert a vacuum force that draws a vacuum on the chamber 640. The vacuum force applied by the vacuum pump 680 may cause the resin material 240 to more fully permeate the fibers 230/sheets 235 of fiber material, and draw air out of the chamber 640 in the direction of the arrow P. The compacting force may continue to be exerted on the second mold 610B, to continue to force the second pattern 615B into the layup of materials 620 as the vacuum pump 680 continues to apply the vacuum force, allowing voids in the resin material 240 to continue to be eliminated, and the layup of materials 620 to continue to be compacted. In some examples, air may be drawn out of the chamber 640 in this manner until a desired level of compaction in the layup of materials 620 is achieved, as shown in FIG. 6B. In some examples, a vacuum pressure in the chamber 640 may be measured by a vacuum gauge 690 to detect when the desired level of compaction of the layup of materials 620 has been achieved.

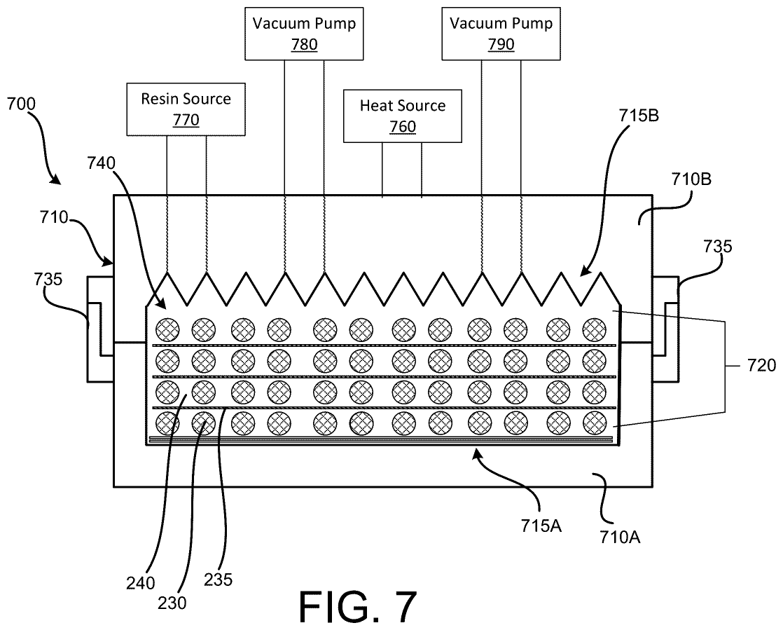

FIG. 7 is a schematic diagram illustrating example operation of an example resin transfer molding apparatus 700, for fabrication of a composite material component including drag reduction features, in accordance with implementations described herein. The example resin transfer molding apparatus 700 includes a mold 710, including a first mold 710A and a second mold 710B. A first pattern 715A is formed in a molding surface of the first mold 710A. In the example shown in FIG. 7, a cross-sectional contour of the first pattern 715A is substantially flat, simply for purposes of discussion and illustration. A second pattern 715B is formed in a molding surface of the second mold 710B. In the example arrangement shown in FIG. 7, a configuration, or shape, or contour, of the second pattern 715B defined in the second mold 710B corresponds to the configuration and/or shape and/or contour of the drag reduction features to be incorporated into the composite material component 200 described above. For example, a configuration, or shape, or contour of the second pattern 715B may correspond to the configuration and/or shape and/or contour of the plurality of riblets 250 to be formed in the fluid-dynamic surface of the example composite material component 200 as described above. In some examples, the first mold 710A and/or the second mold 710B is made of a rigid material that can maintain the example, configuration, or shape, or contour of the first pattern 715A and/or the second pattern 715B, under thermal and/or pressure forces applied to the first mold 710A and/or the second mold 710B during fabrication of the example composite material component 200.

Materials 720 may be laid, for example, sequentially laid, into the first mold 710A. In the example shown in FIG. 7, the example layup of materials 720 includes the example plurality of fibers 230 and/or sheets 235 of fiber material (only one of which is labeled in FIG. 7; see FIGS. 2B-2D for more detail). The mold 710 is closed by closing the second mold 710B onto the first mold 710A, and actuating one or more seals 735 to enclose a chamber 740 defined between the first mold 710A and the second mold 710B. With the mold 710 closed in this manner, a resin material, such as the resin material 240 described above, may be filled into the layup of materials 720 received in the chamber 740. In some examples, the resin material 240 is supplied by a resin source 770 and directed into the chamber 740 in which the layup of materials 720 is received via a corresponding resin port. In some examples, the resin material 240 is injected into the chamber 640 in another manner. The resin material 240 may fill voids in the chamber 740 defined within the mold 710 that are not otherwise occupied by fibers 230 and/or sheets 235 of fiber material. In some examples, a vacuum force may be applied, for example, by a vacuum pump 780, to allow the resin to fully permeate the fibers 230/sheets 235 of fiber material, and to compact voids in the resin material 240. In some examples, the vacuum force may be applied in this manner until a desired level of compaction in the layup of materials 720 is achieved. In some examples, a vacuum pressure in the chamber 740 may be measured by a vacuum gauge 790 to detect when the desired level of compaction of the layup of materials 720 has been achieved. In some examples, heat may be applied to the mold 710, for example by a heat source 760, for curing of the resin material 240. In some examples, the heat may continue to be applied until a desired level of curing of the resin material 240 is achieved.

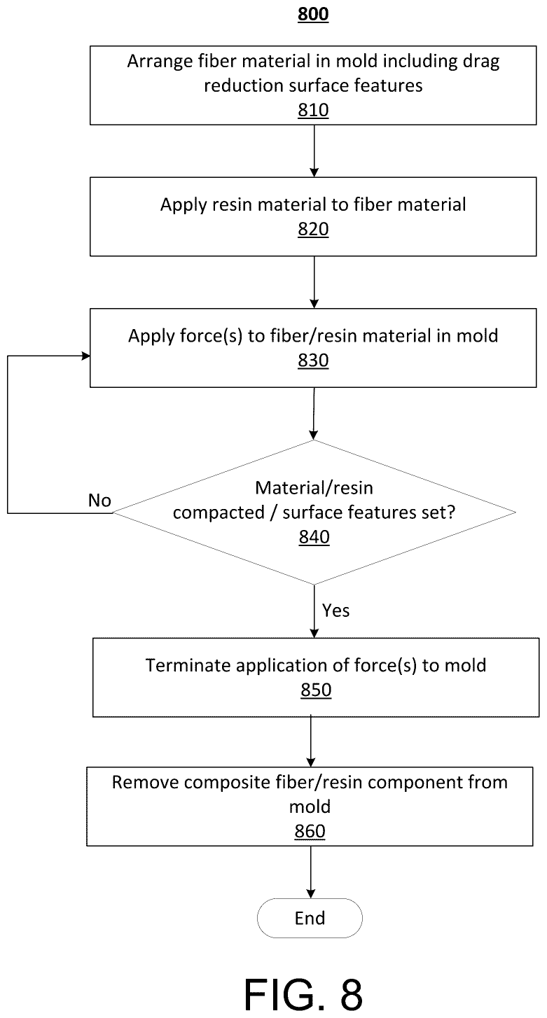

FIG. 8 is a flowchart of an example method 800, in accordance with example implementations described herein. The example method may be applied to the fabrication of surface features into a composite material component. In particular, the example method may be applied to the integral incorporation of surface features into a composite material component. The surface features may include, for example, drag reduction features, including for example the plurality of riblets 250 described above, into a composite material component of an aircraft, and in particular, to a composite material component forming an outer skin portion of the aircraft. In the example method 800, fiber material is arranged in a mold (block 810). The fiber material may include, for example, strands of fibers, sheets of fiber material, and/or a combination thereof. The mold may include molds as described above with respect to FIGS. 4A-7, or other types of molds having a pattern formed therein corresponding to the desired drag reduction features to be integrally incorporated into a surface of the composite material component. A resin material is applied to the fiber material arranged in the mold (block 820). The resin material may be applied to the fiber material during a layup process in which the fiber material is arranged in the mold, and/or may be injected into the mold after the fiber material is arranged in the mold, and/or a combination thereof.

Force(s) are applied to the fiber and resin material received in the mold (block 830). In some examples, the forces include a vacuum force applied to the fiber and resin material, allowing the resin material to further permeate the fiber material, and to eliminate voids in the resin material, as described above with respect to FIGS. 4A-7. In some examples, the forces include an external pressure force applied to a portion of the mold, to force the portion of the mold into the fiber/resin material in the mold, as described above with respect to FIGS. 5A-7. In some examples, the forces include thermal forces, or the application of heat to the mold, to facilitate the curing of the resin material, as described above with respect FIG. 7.

In response to detection that the fiber/resin material received in the mold has achieved a desired level of compaction (block 840) the application of force(s) to the mold is terminated (block 850), and the composite fiber/resin component may be removed from the mold (block 860). In some examples, detection that the desired level of compaction has been achieved may be made based on a vacuum pressure detected within the portion of the mold in which the mold in which the fiber/resin material is received.

A number of embodiments have been described. Nevertheless, it will be understood that various modifications may be made without departing from the spirit and scope of the specification.

Logic flows depicted in the figures, if any, do not require the particular order shown, or sequential order, to achieve desirable results. In addition, other steps may be provided, or steps may be eliminated, from the described flows, and other components may be added to, or removed from, the described systems.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A composite material component, including:
a resin material;
fiber materials arranged in the resin material; and
a plurality of riblets integrally formed in an external surface of the resin material, the external surface of the resin material defining a fluid-dynamic surface of the composite material component.

2. The composite material component of claim 1, wherein each of the plurality of riblets has substantially the same cross-sectional shape.

3. The composite material component of claim 1, wherein each of the plurality of riblets has a triangular cross-sectional shape.

4. The composite material component of claim 1, wherein each of the plurality of riblets has a cross-sectional shape defined by an equilateral triangle.

5. The composite material component of claim 1, wherein peaks of the plurality of riblets form an acute angle.

6. The composite material component of claim 1, wherein troughs between adjacent riblets of the plurality of riblets form an acute angle.

7. The composite material component of claim 1, wherein the plurality of riblets are arranged substantially in parallel to each other along a longitudinal direction of the plurality of riblets.

8. The composite material component of claim 1, wherein
a spacing between peaks of adjacent riblets of the plurality of riblets is substantially uniform across the plurality of riblets, and
a spacing between troughs formed between adjacent riblets of the plurality of riblets is substantially uniform across the plurality of riblets.

9. The composite material component of claim 1, wherein the composite material component is a skin portion of an aircraft, and wherein the plurality of riblets are integrally formed in the resin material defining an aerodynamic surface of the skin portion of an aircraft to reduce skin friction drag at the aerodynamic surface of the skin portion of the aircraft.

10. The composite material component of claim 9, wherein the plurality of riblets integrally formed in the resin material defining the aerodynamic surface of the skin portion of the aircraft, in a direction corresponding to an airflow direction at the aerodynamic surface of the skin portion of the aircraft.

11. The composite material component of claim 1,
wherein the composite material component comprises at least one of a fuselage portion of an aircraft, a wing portion of the aircraft, a nacelle portion of the aircraft, or a control surface portion of the aircraft, and
wherein the plurality of riblets are integrally formed in the resin material defining an aerodynamic surface of the composite material component, aligned with an airflow direction at the aerodynamic surface of the composite material component.

12. A method of fabricating a composite material component, comprising:
arranging fiber material in a mold, the mold having a pattern formed therein, the pattern defining a plurality of riblets;
sealing a vacuum bagging film over the fiber material arranged in the mold to form a chamber;
applying a resin material to the fiber material arranged in the mold;
applying a force to the chamber in which the fiber material and the resin material are received; and
compacting the fiber material and the resin material in the chamber in response to application of the force such that the plurality of riblets are integrally formed in the resin material of the composite material component.

13. The method of claim 12, wherein applying the resin material includes injecting the resin material into the chamber after sealing the vacuum bagging film over the fiber material arranged in the mold.

14. The method of claim 12, wherein applying the resin material includes applying the resin material to the fiber material received in the mold prior to sealing the vacuum bagging film over the fiber material arranged in the mold.

15. The method of claim 12, wherein applying the force includes applying a vacuum force, and further comprising:
drawing air out of the chamber and compacting the fiber material and the resin material received in the chamber in response to application of the vacuum force.

16. The method of claim 12, wherein the mold includes a first mold having a first pattern formed therein, and a second mold having a second pattern formed therein, and wherein applying the force includes applying a compacting force that forces the second mold toward the first mold, and forces the second pattern into a corresponding surface of the resin material.

17. The method of claim 12, further comprising:
applying heat to the fiber material and the resin material in the chamber; and
curing the resin material in response to application of the heat.

18. A composite material component for an aircraft, comprising:
a resin material;
fiber materials arranged in the resin material; and
a plurality of riblets integrally formed in an external surface of the resin material, the external surface defining an aerodynamic surface of a skin portion of the aircraft.

19. The composite material component of claim 18, wherein the plurality of riblets are aligned with an airflow direction of the aerodynamic surface of the composite material component.

20. The composite material component of claim 18, wherein the composite material component forms at least at portion of one of a fuselage portion of the aircraft, a wing portion of the aircraft, a nacelle portion of the aircraft, or a stability and control portion of the aircraft.
